(19) United States
(12) Patent Application Publication
(10) Pub. No.: US 2015/0381959 A1
(43) Pub. Date: Dec. 31, 2015

(54) IMAGE PROCESSING DEVICE AND METHOD THEREFOR

(71) Applicant: LG ELECTRONICS INC., Seoul (KR)

(72) Inventor: Yonguk LEE, Pyeongtaek-si (KR)

(73) Assignee: LG ELECTRONICS INC., Seoul (KR)

(21) Appl. No.: 14/765,540

(22) PCT Filed: Oct. 25, 2013
(86) PCT No.: PCT/KR2013/009578

§ 371 Date: Aug. 3, 2015

(30) Foreign Application Priority Data
Mar. 5, 2013 (KR) 10-2013-0023541

(51) Int. Cl. H04N 13/00; H04N 13/02; H04N 13/04; G06T 7/00

(52) U.S. Cl. CPC H04N 13/0022; G06T 7/0075; H04N 13/0239; H04N 13/0037; H04N 13/0497; G06T 2207/10012; H04N 2013/0081; G06T 2207/10024

(57) ABSTRACT

The present specification relates to an image processing device capable of compensating for a 3D image distorted by a screen curvature of a 3D-curved display, and a method therefore. The image processing method according to one embodiment of the present specification includes: receiving a 3D image signal; changing a depth value of a left-eye image and a right-eye image included in the received 3D image signal, according to a screen curvature of an image display device; and displaying the left-eye image and the right-eye image updated based on the changed depth value, such that the 3D image signal is output after being compensated.

### TECHNICAL FIELD

The present invention relates to an image processing device and a method therefor.

### BACKGROUND ART

An image display device includes a device for receiving and displaying broadcasting or recording and playing moving images, and a device for recording and playing audio. The image display device includes a television, a computer monitor, a projector, a tablet, etc.

Such image display device has become increasingly more functional. Examples of such functions include not only reproducing broadcasting, music or moving images, but also capturing images and video, playing games, receiving broadcasting, etc. The image display device is configured as a multimedia player. Recently, the image display device is implemented as a smart device (e.g., smart television). The image display device executes an Internet function, and operates in connection with a mobile terminal or a computer.

Recently, as concerns about a stereoscopic image service rise, devices for providing a stereoscopic image are being developed. Generally, a three-dimensional (3D) image display device is configured to display a 3D image on a flat panel. For instance, the 3D image display device detects depth information of a stereoscopic object included in a 3D image, and displays the 3D image on a flat panel based on the detected depth information. The conventional device and method for generating a distorted image for a curved screen have been disclosed in Korean Patent Application No. 10-2009-0048982.

### DISCLOSURE OF THE INVENTION

Therefore, an object of the present invention is to provide an image processing device capable of compensating for a 3D image distorted by a screen curvature of a 3D curved display, and a method therefor.

To achieve these and other advantages and in accordance with the purpose of the present invention, as embodied and broadly described herein, there is provided an image processing device, including: a receiving unit configured to receive a 3D image signal having a left-eye image and a right-eye image; a controller configured to change a depth value of the left-eye image and the right-eye image, according to a screen curvature of an image display device; and a 3D curved-surface display configured to display the left-eye image and the right-eye image updated based on the changed depth value, such that the 3D image signal is output after being compensated.

In an embodiment of the present invention, the controller may change the depth value of the left-eye image and the right-eye image included in the received 3D image signal according to the screen curvature, when the image display device is in a compensation mode.

In an embodiment of the present invention, the controller may control the depth value of the left-eye image and the right-eye image according to a user's input, or may control the changed depth value according to the user's input.

In an embodiment of the present invention, upon change of the curvature screen of the image display device, the controller may change the depth value of the left-eye image and the right-eye image included in the received 3D image signal, according to the changed screen curvature. In an embodiment of the present invention, the image processing device may further include a driving unit configured to change a screen curvature of the image display device.

In an embodiment of the present invention, upon reception of a request for changing the screen curvature, the controller may generate a control signal for changing the screen curvature of the image display device according to the request, and may output the generated control signal to the driving unit.

In an embodiment of the present invention, the image processing device may further include a storage unit configured to pre-store a depth value of the screen curvature corresponding to a pixel position of the image display device in a curvature table. The controller may read a curved depth corresponding to a display position of the left-eye image and the right-eye image, from the curvature table. Then, the controller may deduct the read curved depth, from the depth value of the left-eye image and the right-eye image, thereby changing the depth value of the left-eye image and the right-eye image.

To achieve these and other advantages and in accordance with the purpose of the present invention, as embodied and broadly described herein, there is also provided an image processing method, including: receiving a 3D image signal; changing a depth value of a left-eye image and a right-eye image included in the received 3D image signal, according to a screen curvature of an image display device; and displaying the left-eye image and the right-eye image updated based on the changed depth value, such that the 3D image signal is output after being compensated.

The present invention has the following advantages.

Firstly, in the image processing device and the method therefor according to embodiments of the present invention, a 3D image distorted by a screen curvature of a 3D curved-surface display can be compensated as a depth value corresponding to a disparity between a left-eye image and a right-eye image included in a 3D image signal is compensated (changed) according to the screen curvature of the 3D curved-surface display.

In the image processing device and the method therefor according to embodiments of the present invention, a 3D image distorted by a screen curvature of a 3D curved-surface display can be effectively compensated as a depth value corresponding to a disparity between a left-eye image and a right-eye image included in a 3D image signal is selectively compensated (changed) according to the screen curvature of the 3D curved-surface display, or as the compensated depth value is controlled according to a user's input.

In the image processing device and the method therefor according to embodiments of the present invention, a 3D image distorted by change of a screen curvature of a 3D curved-surface display can be compensated as a depth value corresponding to a disparity between a left-eye image and a right-eye image included in a 3D image signal is compensated (changed) according to change of the screen curvature of the 3D curved-surface display.

### BRIEF DESCRIPTION OF THE DRAWINGS

FIG. 1 is a block diagram illustrating an image display device and an external input device according to the present invention;

FIG. 2 is a view illustrating a configuration of a 3D image display device to which an image processing device according to embodiments of the present invention has been applied;

FIGS. 3A and 3B are exemplary views illustrating a stereoscopic object (a left-eye image and a right-eye image) displayed on a screen of a flat panel;

FIG. 4 is an exemplary view illustrating a stereoscopic object displayed on a 3D curved-surface display;

FIG. 5 is a flowchart illustrating an image processing method according to a first embodiment of the present invention;

FIG. 6 is an exemplary view illustrating a controller of the image processing method according to a first embodiment of the present invention;

FIG. 7 is an exemplary view illustrating a curvature table according to a first embodiment of the present invention;

FIG. 8 is a flowchart illustrating an image processing method according to a second embodiment of the present invention;

FIG. 9 is an exemplary view illustrating a displayed window according to a second embodiment of the present invention;

FIG. 10 is an exemplary view illustrating a depth control bar displayed according to a second embodiment of the present invention;

FIG. 11 is a flowchart illustrating an image processing method according to a third embodiment of the present invention;

FIG. 12 is an exemplary view illustrating a screen curvature control bar according to a third embodiment of the present invention; and

FIG. 13 is an exemplary view illustrating a changed state of a screen curvature according to a third embodiment of the present invention.

### MODES FOR CARRYING OUT THE PREFERRED EMBODIMENTS

Unless differently defined, all the terms used herein with including technical or scientific terms have the same meaning as terms generally understood by those skilled in the art relating to the field of the present invention. Terms defined in a general dictionary should be understood so as to have the same meanings as contextual meanings of the related art. Unless definitely defined in the present invention, the terms are not interpreted as ideal or excessively formal meanings. Furthermore, when the technical terms used in the present invention are unsuitable technical terms that do not precisely express the techniques of the present invention, the unsuitable technical terms should be replaced by suitable technical terms that can be understood by those skilled in the art. The general terms used in the present invention should be interpreted based on the previous or next contexts, but should not be interpreted as an excessively narrowed meaning.

A singular expression includes a plural concept unless there is a contextually distinctive difference therebetween. In the present invention, a term of “include” or “have” should not be interpreted as if it absolutely includes a plurality of components or steps of the specification. Rather, the term of “include” or “have” may not include some components or some steps, or may further include additional components.

It will be understood that although the terms first, second, etc. may be used herein to describe various elements, these elements should not be limited by these terms. These terms are generally only used to distinguish one element from another. For instance, a first component may be referred to as a second component, and a second component may be also referred to as a first component within the scope of the present invention.

Preferred embodiments according to the present invention are described with reference to the accompanying drawings. Similar elements are provided with similar reference numerals and descriptions of the similar elements will be omitted.

When it is determined that a detailed description of a technology known in the related art prevents the nature and gist of the present invention from being made apparent, the detailed description of the technology is omitted. In addition, the accompanying drawings are only for helping get an easy understanding of the idea of the present invention and notably, should not be construed as imposing any limitation on the idea of the invention.

An image display device according to the present disclosure may include both a device for receiving and outputting broadcasting or recording and/or reproducing images, and a device for recording and/or reproducing audio. Hereinafter, a TV as an example of the image display device will be illustrated.

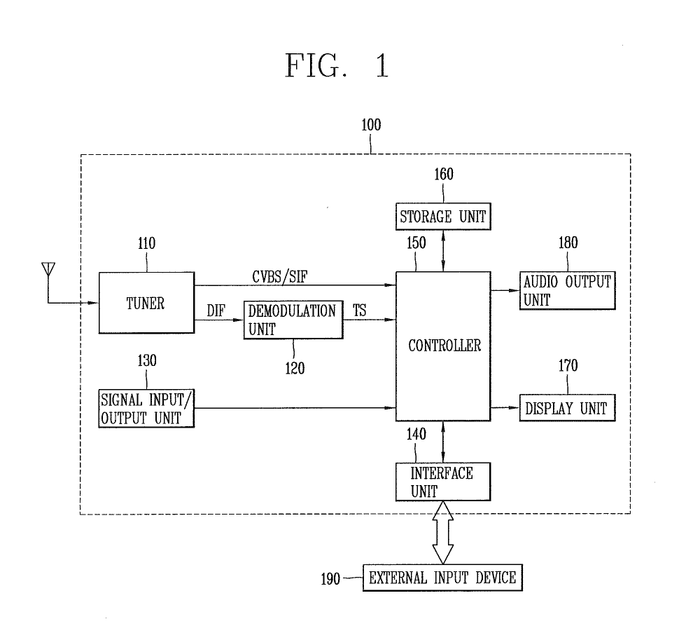

FIG. 1 is a block diagram of an image display device 100 and an external input device 190 according to the present disclosure. The image display device 100 includes a tuner 110, a demodulation unit 120, a signal input/output unit 130, an interface unit 140, a controller 150, a storage unit 160, a display unit 170 and an audio output unit 180. However, the external input device 190 may be a separate device from the image display device 100, or may be included in the image display device 100.

Referring to FIG. 1, the tuner 110 may select a radio frequency (RF) broadcast signal, which corresponds to a channel selected by a user, among RF broadcast signals received through an antenna, or every pre-stored channel. The tuner 110 may also convert the selected RF broadcast signal into a medium frequency signal or a baseband video or audio signal. For example, when the RF broadcast signal selected is a digital broadcast signal, the tuner 110 may convert the RF broadcast signal into a digital IF signal (DIF). On the other hand, when the RF broadcast signal is an analog broadcast signal, the tuner 110 may convert the RF broadcast signal into an analog baseband video or audio signal (CVBS/SIF). That is, the tuner 110 may be a hybrid tuner for processing a digital broadcast signal and an analogue broadcast signal.

The digital IF signal (DIF) output from the tuner 110 may be input to the demodulation unit 120, and the analog baseband video or audio signal (CVBS/SIF) output from the tuner 110 may be input directly to the controller 150. Also, the tuner 110 may receive a single carrier RF broadcast signal according to an advanced television systems committee (ATSC) standard, or a multi-carrier RF broadcast signal according to a digital video broadcasting (DVB) standard.

Although the tuner 110 is illustrated in one in the drawings, the image display device 100 may include a plurality of tuners, e.g., a first tuner and a second tuner. In this case, the first tuner may receive a first RF broadcast signal corresponding to a broadcast channel selected by a user, and the second tuner may receive a second RF broadcast signal corresponding to a pre-stored broadcast channel sequentially or periodically. Like the first tuner, the second tuner may convert an RF broadcast signal into a digital IF signal (DIF), or may convert the RF broadcast signal into an analog baseband video or audio signal (CUBS/SIF).

The demodulation unit 120 may execute a demodulation operation by receiving a digital IF signal (DIF) converted in the tuner 110.

For example, when the digital IF signal outputted from the tuner 110 is a signal according to the ATSC standard, the demodulation unit 120 may perform an 8-vestigal side band (8-VSB) demodulation. Here, the demodulation unit 120 may also perform a trellis decoding, a de-interleaving, a reed Solomon decoding and the like. To this end, the demodulation unit 120 may include a trellis decoder, a de-interleaver, a reed Solomon decoder and the like.

As another example, when the digital IF signal (DIF) outputted from the tuner 110 is a signal according to a DVB standard, the demodulation unit 120 may perform a coded orthogonal frequency division modulation (COFDMA) demodulation. Here, the demodulation unit 120 may also perform a convolution decoding, a de-interleaving, a reed Solomon decoding and the like. To this end, the demodulation unit 120 may include a convolution decoder, a de-interleaver, a reed Solomon decoder and the like.

The signal input/output unit 130 performs a signal input and a signal output by being connected to an external device, and may include an A/V input/output unit and a wireless communication unit.

The A/V input/output unit may include an Ethernet terminal, a USB terminal, a composite video banking sync (CUBS) terminal, a component terminal, a S-video terminal (analog), a digital visual interface (DVI) terminal, a high definition multimedia interface (HDMI) terminal, a mobile high-definition link (MHL) terminal, an RGB terminal, a D-SUB terminal, an IEEE 1394 terminal, an SPDIF terminal, a liquid HD terminal, etc. A digital signal input through such terminals may be transmitted to the controller 150. An analogue signal input through the CVBS terminal and the S-video terminal may be converted into a digital signal through an analogue/digital conversion unit (not shown), and then may be transmitted to the controller 150.

The wireless communication unit may execute wireless Internet access. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like. The wireless communication unit may execute short-range wireless communication with other electronic devices. The wireless communication unit may execute short-range wireless communication according to communication standards, such as Bluetooth, radio frequency identification (RFID), infrared data association (IrDA), ultra wideband (UWB), Zigbee and the like.

The signal input/output unit 130 may be connected to an external device, such as a digital versatile disk (DVD) player, a Bluray, a game machine, a camera, a camcorder, a laptop computer (notebook), a portable device and a smart phone. The signal input/output unit 130 may transfer a video, audio or data signal input from the exterior via the connected external device to the controller 150 of the image display device 100. Also, the signal input/output unit 130 may transfer a video, audio or data signal of various media files stored in an external storage device such as a memory device and a hard disk, to the controller 150. The video, audio or data signal processed by the controller 150 may be output to other external device.

The signal input/output unit 130 may be connected to a set-top box such as an Internet protocol TV (IPTV) set-top box, through at least one of the aforementioned terminals, thereby executing a signal input and a signal output. For instance, the signal input/output unit 130 may transmit an image signal, a voice signal and a data signal processed by an IPTV set-top box, to the controller 150, for bi-directional communication. Alternatively, the signal input/output unit 130 may transmit signals processed by the controller 150, to the IPTV set-top box. The IPTV may indicate ADSL-TV, VDSL-TV, FTTH-TV or the like, according to a type of transmission network.

A digital signal output from the demodulation unit 120 and the signal input/output unit 130 may include a stream signal (TS). The stream signal (TS) may be a signal in which a video signal, an audio signal and a data signal are multiplexed. As one example, the stream signal (TS) may be an MPEG-2 transport stream (TS) signal obtained by multiplexing an MPEG-2 video signal and a Dolby AC-3 audio signal. In detail, an MPEG-2 TS signal may include a 4-byte header and a 184-byte payload.

The interface unit 140 may receive a user input signal, such as a power on/off, a channel selection and a screen setting from the external input device 190, or may transmit signals processed by the controller 150 to the external input device 190. The interface unit 140 and the external input device 190 may be connected to each other in a wired or wireless manner.

As an example of the interface unit 140, a sensor may be provided. The sensor is configured to sense the input signal using a remote controller, for instance.

A network interface unit (not shown) provides an interface for connecting the image display device 100 to a wired or wireless network which includes an Internet network. The network interface unit may include an Ethernet terminal for connection to the wired network, and use communication standards, such as wireless LAN (WLAN) (Wi-Fi), wireless broadband (Wibro), world interoperability for microwave access (Wimax), high speed downlink packet access (HSDPA) and the like for connection to the wireless network.

The network interface unit (not shown) may access a predetermined web page through a network. That is, the network interface unit may transmit or receive data to or from a corresponding server, by accessing a predetermined web page. Also, the network interface unit may receive contents or data provided by a contents provider or a network operator. That is, the network interface unit may receive contents, such as a movie, an advertisement, a game, a VOD, a broadcast signal provided by the network operator, and related information via a network. The network interface unit may also receive update information related to firmware and update files provided by the network operator. Also, the network interface unit may transmit data to the contents provider or the network operator.

The network interface unit (not shown) may select a desired application among applications open to the public, via a network, and then may receive the selected application.

The controller 150 may control an entire operation of the image display device 100. More specifically, the controller 150 is formed to control generation and output of an image. For instance, the controller 150 may control the tuner 110 to tune an RF broadcast signal corresponding to a channel selected by a user or a pre-stored channel. Although not shown, the controller 150 may include a de-multiplexer, an image processor, a voice processor, a data processor, an On Screen Display (OSD) generator, etc. The controller 150 may include a CPU, a peripheral device, etc. by hardwared.

The controller 150 may divide a stream signal (TS), e.g., an MPEG-2 TS, into an image signal, a voice signal and a data signal by a demultiplexing process.

The controller 150 may execute an image processing, e.g., a decoding process, with respect to a demultiplexed image signal. More specifically, the controller 150 may decode a coded image signal of an MPEG-2 standard by using an MPEG-2 decoder, and may decode a coded image signal of an H. 264 standard based on a digital multimedia broadcasting (DMB) method or a DVB-H, by using an H. 264 decoder. The controller 150 may execute an image processing with respect to an image signal, such that a brightness, a tint, a color, etc. of the image signal are controlled. The image signal processed by the controller 150 may be transmitted to the display unit 170, or may be transmitted to an external output device (not shown) through an external output terminal.

The controller 150 may execute a voice processing with respect to a demultiplexed voice signal, e.g., a decoding process. More specifically, the controller 150 may decode a coded voice signal of an MPEG-2 standard by using an MPEG-2 decoder, and may decode a coded voice signal of an MPEG-4 bit sliced arithmetic coding (BSAC) standard based on a DMB method by using an MPEG-4 decoder. And the controller 150 may decode a coded voice signal of an MPEG-2 advanced audio codec (AAC) standard based on a DMB method or a DVB-H method by using an AAC decoder. The controller 150 may control a base, a treble, a sound, etc. A voice signal processed by the controller 150 may be transmitted to the audio output unit 180, e.g., a speaker, or may be transmitted to an external output device.

The controller 150 may execute a signal processing with respect to an analog baseband video or audio signal (CVBS/SIF). The analog baseband video or audio signal (CVBS/SIF) input to the controller 150 may be an analog baseband video or audio signal output from the tuner 110 or the signal input/output unit 130. The processed video signal is displayed on the display unit 170, and the processed audio signal is output through the audio output unit 180.

The controller 150 may execute a data processing with respect to a demultiplexed data signal, e.g., a decoding process. The data signal may include electronic program guide (EPG) information including broadcasting information such as a starting time and an ending time of a broadcasting program provided on each channel. The EPG information may include ATSC-Program and System Information Protocol (ATSC-PSIP) information based on an ATSC method, and may include DVB-Service Information (DVB-SI) based on a DVB method. The ATSC-PSIP information or the DVB-SI information may be included in a header (4 bytes) of an MPEG-2 TS.

The controller 150 may execute a control operation for an OSD processing. More specifically, the controller 150 may generate an OSD signal for displaying various types of information in the form of a graphic or a text, based on at least one of an image signal and a data signal, or based on an input signal received from the external input device 190. The OSD signal may include various data such as a user interface screen, a menu screen, a widget, and an icon of the image display device 100.

The storage unit 160 may store therein a program for signal processing and control of the controller 150, or may store therein a video signal, an audio signal and a data signal which have been processed. The storage unit 160 may include at least one storage medium of a flash memory-type storage medium, a hard disc-type storage medium, a multimedia card micro-type storage medium, a card-type memory (for example, SD or XD memory), a random access memory (RAM), a read-only memory (ROM), an electrically erasable programmable ROM (EEPROM), a programmable ROM (PROM), a magnetic memory, a magnetic disk, and an optical disk.

The display unit 170 may convert a video signal, a data signal, an OSD signal, etc. processed by the controller 150 into an RGB signal, thereby generating a driving signal. With such a configuration, the display unit 170 outputs an image. The display unit 170 may be implemented as a plasma display panel (PDP), a liquid crystal display (LCD), a thin film transistor-liquid crystal display (TFT-LCD), an organic light emitting diode (OLED), a flexible display, a 3-dimensional (3D) display, an e-ink display, etc. The display unit 170 may serve as an input device by being implemented as a touch screen.

The audio output module 180 outputs a voice signal processed by the controller 150, e.g., a stereo signal or a 5.1 channel signal. The audio output module 180 may be implemented as various types of speakers.

The image display device 100 may further include a capturing unit (not shown) configured to capture a user. The capturing unit (not shown) may be implemented as a single camera. However, the present invention is not limited to this. That is, the capturing unit may be implemented as a plurality of cameras. Information on an image captured by the capturing unit (not shown) is input to the controller 150.

The image display device 100 may further include a sensing unit (not shown) having at least one of a touch sensor, a voice sensor, a position sensor, and an operation sensor, so as to sense a user's gesture. A signal sensed by the sensing unit (not shown) may be transmitted to the controller 150 through the interface unit 140.

The controller 150 may sense a user's gesture based on an image captured by the capturing unit (not shown) or a signal sensed by the sensing unit (not shown), or by combining the image with the signal.

A power supply unit (not shown) supplies power to each component of the image display device 100. Especially, the power supply unit may supply power to the controller 150 which may be implemented in a form of a system on chip (SOC), the display unit 170 to display an image, and the audio output unit 180 to output an audio.

To this end, the power supply unit (not shown) may be provided with a converter (not shown) for converting an alternating current power into a direct current power. For instance, in a case where the display unit 170 is implemented as a liquid crystal panel having a plurality of backlight lamps, the power supply unit may further include an inverter (not shown) which can execute a PWM operation for a brightness change or a dimming driving.

The external input device 190 is connected to the interface unit 140 by wire or wirelessly, and transmits an input signal generated by a user's input to the interface unit 140. The external input device 190 may include a remote controller, a mouse, a keyboard, etc. The remote controller may transmit an input signal to the interface unit 140, via Bluetooth, RF communication, infrared ray communication, Ultra Wideband (UWB), ZigBee, etc. The remote controller may be implemented as a spatial remote controller. The spatial remote controller may generate an input signal by sensing an operation of the body in space.

The image display device 100 may be a fixed digital broadcast receiver capable of receiving at least one of ATSC (8-VSB) broadcast programs, DVB-T (COFDM) broadcast programs, DVB-C (QAM) broadcast programs, DVB-S (QPSK) broadcast programs, and ISDB-T (BST-OFDM) broadcast programs. Alternatively, the image display device 100 may be a mobile digital broadcast receiver capable of receiving at least one of terrestrial DMB broadcast programs, satellite DMB broadcast programs, ATSC-M/H broadcast programs, DVB-H (COFDM) broadcast programs, and Media Forward Link Only (MediaFLO) broadcast programs. Alternatively, the image display device 100 may be an IPTV digital broadcast receiver capable of receiving cable broadcast programs, satellite broadcast programs or IPTV programs.

The image display device of the present invention is configured to provide a stereoscopic image. A term of 3D (3-D) is used to explain a technique to display or visually represent a stereoscopic image (hereinafter, will be referred to as a 3D image) having an optical illusion in depth. An observer's visual cortex with respect to a left-eye image and a right-eye image interprets two images as a single 3D image.

A 3D image display technique means a technique to execute a 3D image processing with respect to a device which can display an image. An observer may be effectively provided with a 3D image from the device which can display an image, through a special observation device.

The 3D image processing technique includes capturing stereoscopic images/videos, capturing multi-view images/videos using a plurality of cameras, processing 2D images and depth information, etc. The device which can display an image includes a liquid crystal display (LCD) having hardware and/or software for supporting a 3D image display technique, a digital TV screen, a computer monitor, etc. The special observation device includes specialized glasses, a goggle, a head gear, an eyewear, etc.

More specifically, the 3D image display technique includes an anaglyph stereoscopic image display (generally using passive red-blue glasses), a polarized stereoscopic image display (generally using passive polarized glasses), an alternate-frame sequencing (generally using active shutter glasses/head gear), an auto-stereoscopic display using a lenticular or barrier screen, etc.

For a 3D image processing, a stereoscopic image or a multi-view image may be transmitted by being reduction-encoded by a plurality of methods including a moving picture experts group (MPEG). For instance, a stereoscopic image or a multi-view image may be transmitted by being reduction-encoded by an H.264/AVC (advanced video coding) method. A receiving system may obtain a 3D image by decoding a received image in a reverse manner to the H.264/AVC method. In this case, the receiving system may be provided as a component of a 3D image display device.

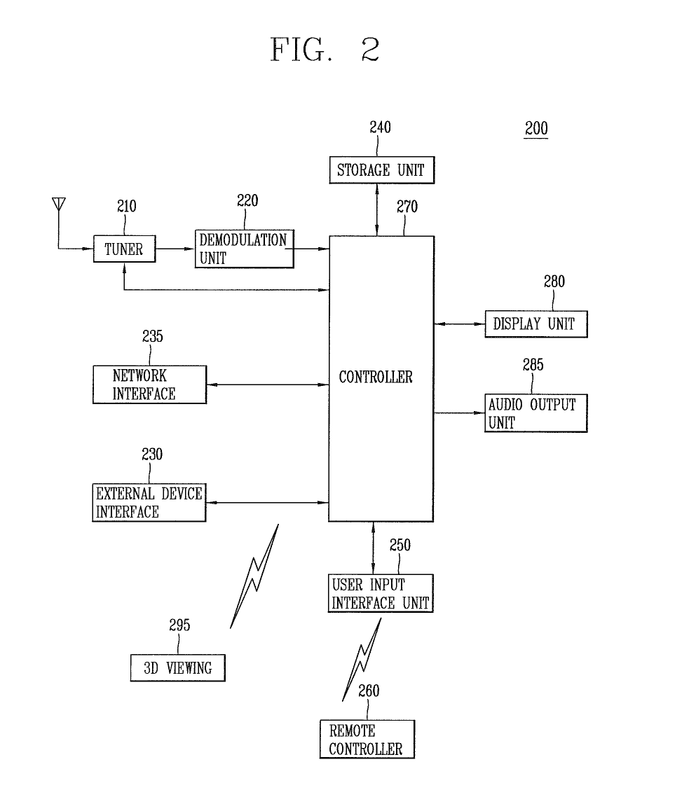

Hereinafter, a 3D image display device 200 will be explained with reference to FIG. 2.

FIG. 2 is a view illustrating a configuration of the 3D image display device to which the image processing device according to embodiments of the present invention has been applied.

As shown in FIG. 2, the 3D image display device 200 according to embodiments of the present invention may include a tuner 210, a demodulation unit 220, an external device interface unit 230, a network interface unit 235, a storage unit 240, a user input interface unit 250, a controller 270, a display unit 280, an audio output unit 285, and a 3D viewer 295. Hereinafter, components related to output of a 3D image will be explained with reference to the same components as those of FIG. 1, and the aforementioned explanations will be omitted.

The tuner 210 detects a signal by receiving a broadcasting signal, and generates a transport stream with respect to a left-eye image and a right-eye image by correcting an error.

The demodulation unit 220 may include a first decoder for decoding a reference view video, and a second decoder for decoding an extended view video. If a video stream corresponds to a reference view video, it is output to the first decoder. On the other hand, if a video stream corresponds to an extended view video, it is output to the second decoder.

The external device interface unit 230 may be configured to transmit or receive data to or from an external device connected thereto. For this, the external device interface unit 230 may include an A/V input/output unit (not shown) or a wireless communication unit (not shown).

The external device interface unit 230 may be connected to an external device (not shown) such as a digital versatile disc (DVD), a Blu-ray disc, a game machine, a camera, a computer (notebook), by wire or wirelessly. The external device interface unit 230 transmits an image, voice or data signal input from the outside through an external device connected thereto, to the controller 270 of the image display device 200. The image, voice or data signal processed by the controller 270 may be output to the external device. For this, the external device interface unit 230 may include an A/V input/output unit (not shown) or a wireless communication unit (not shown).

The A/V input/output unit may include a USB terminal, a composite video banking sync (CUBS) terminal, a component terminal, an S-video terminal (analogue), a digital visual interface (DVI) terminal, a high definition multimedia interface (HDMI) terminal, an RGB terminal, a D-SUB terminal, etc., such that an image signal and a voice signal from an external device are input to the image display device 200.

The wireless communication unit may execute short-range wireless communication with other electronic device. The image display device 200 may be connected to other electronic device via a network, according to a communication standard such as Bluetooth, radio frequency identification (RFID), infrared data association (IrDA), ultra wideband (UWB), Zigbee and digital living network alliance (DLNA).

The external device interface unit 230 may be connected to one of various set-top boxes and the aforementioned various types of terminals, and may execute an input/output operation with the set-top box.

The external device interface unit 230 may transceive (transmit and receive) data with the 3D viewer 295.

The network interface unit 235 provides an interface for connecting the image display device 200 to a wired or wireless network which includes an Internet network. The network interface unit 235 may include an Ethernet terminal for connection to the wired network, and use communication standards, such as wireless LAN (WLAN) (Wi-Fi), wireless broadband (Wibro), world interoperability for microwave access (Wimax), high speed downlink packet access (HSDPA) and the like for connection to the wireless network.

The network interface unit 235 may receive contents or data provided by a contents provider or a network operator via a network. That is, the network interface unit 235 may receive contents, such as a movie, an advertisement, a game, a VOD, a broadcast signal provided by the network operator, and related information via a network. The network interface unit 235 may also receive update information related to firmware and update files provided by the network operator. Also, the network interface unit 235 may transmit data to the contents provider or the network operator.

The network interface unit 235 may be connected to, for example, an Internet protocol (IP) TV, so as to receive a video, audio or data signal processed in an IPTV set-top box and transfer it to the controller 270 for allow bi-directional communication. The network interface unit 235 may also transfer signals processed in the controller 270 to the IPTV set-top box.

The IPTV may indicate ADSL-TV, VDSL-TV, FTTH-TV or the like or indicate TV over DSL, Video over DSL, TV overIP (TVIP), Broadband TV (BTV) or the like, according to a type of transmission network. Also, the IPTV may indicate an Internet-accessible Internet TV, and a full-browsing TV.

The storage unit 240 may store programs for signal processing and control by the controller 270, and also store processed video, audio or data signals.

The storage unit 240 may execute a function of temporarily storing a video, audio or data signal input via the external device interface unit 230. Also, the storage unit 240 may store information related to a predetermined broadcast channel through a channel memory function of a channel map and the like.

The storage unit 240 may include at least one storage medium of a flash memory-type storage medium, a hard disc-type storage medium, a multimedia card micro-type storage medium, a card-type memory (for example, SD or XD memory), a random access memory (RAM), a read-only memory (ROM) (e.g., electrically erasable programmable ROM (EEPROM)), and the like. The image display device 200 may reproduce a file (a video file, a still image file, a music file, a document file, etc.) stored in the storage unit 240 to provide to a user.

FIG. 2 illustrates an exemplary embodiment having the storage unit 240, separate from the controller 270. However, the storage unit 240 may alternatively be configured to be included in the controller 270.

A description of the user input interface unit 250 will be replaced by that of the aforementioned interface unit 140, with reference to FIG. 1.

The controller 270 may demultiplex stream, which is inputted via the tuner 210, the demodulation unit 220 or the external device interface unit 230, or process the demultiplexed signals, to generate and output signals for outputting video or audio.

The video signal processed in the controller 270 may be inputted to the display unit 280 to be outputted as an image corresponding to the image signal. Also, the video signal processed in the controller 270 may be inputted to an external output device through the external device interface unit 230.

The audio signal processed in the controller 270 may be outputted to the audio output unit 285. The audio signal processed in the controller 270 may be inputted to an external output device through the external device interface unit 230.

The controller 270 may include a demultiplexer, an image processor and the like. Besides, the controller 270 may control an overall operation of the image display device 200. For example, the controller 270 may control the tuner 210 to select an RF broadcast corresponding to a user-selected channel or a pre-stored channel.

The controller 270 may also control the image display device 200 by a user command inputted via the user input interface unit 250 or an internal program.

For example, the controller 270 may control the tuner 210 to input a signal of a channel, which is selected in response to a predetermined channel select command received via the user input interface unit 250. The controller 270 may then process a video, audio or data signal of the selected channel. The controller 270 may control information related to the user-selected channel to be outputted through the display unit 280 or the audio output unit 285 together with the processed video or audio signal.

As another example, the controller 270 may control a video signal or an audio signal, which is inputted from an external device, for example, a camera or a camcorder through the external device interface unit 230 in response to an external device image reproduce command received through the user input interface unit 250, to be outputted through the display unit 280 or the audio output unit 285.

In the meantime, the controller 270 may control the display unit 280 to display an image. For example, the controller 270 may control the display unit 280 to output a broadcast image inputted through the tuner 210, an externally input image inputted through the external device interface unit 230, an image inputted through the network interface unit 235, or an image stored in the storage unit 240.

Here, the image output on the display unit 280 may be a still image or a video, and a 2D or 3D image.

The controller 270 may allow a predetermined object within the image displayed on the display unit 280 to be generated and displayed as a 3D object. For example, the object may be at least one of an accessed web screen (a newspaper, a journal, etc.), an electronic program guide (EPG), various menus, a widget, an icon, a still image, a video, and text.

The 3D object may be processed to have a different depth from the image displayed on the display unit 280. Preferably, the 3D object may be processed to seem to protrude more than the image displayed on the display unit 280.

The controller 270 may recognize a user's location based on an image captured by a capturing unit (not shown). For example, the controller 270 may recognize a distance (z-axial coordinates) between a user and the image display device 200. Also, the controller 270 may recognize x-axial coordinates and y-axial coordinates within the display unit 280 corresponding to the user's location.

Although not shown in FIG. 2, the image display device 200 may further include a channel browsing processor, which generates a thumbnail image corresponding to a channel signal or an externally input signal. The channel browsing processor may receive a stream signal outputted from the demodulation unit 220 or a stream signal outputted from the external device interface unit 230, extract an image from the input stream signal, and generate a thumbnail image. The generated thumbnail image may be inputted to the controller 270 as it is or after being encoded. Also, the generated thumbnail image may be inputted to the controller 270 after being encoded into a stream format.

The controller 270 may output on the display unit 280 a thumbnail list including a plurality of thumbnail images using the input thumbnail image. The thumbnail list may be displayed in a briefly viewing manner in which the list is displayed on a partial region with displaying a predetermined image on the display unit 280, or in a fully viewing manner in which the list is displayed on most regions of the display unit 280. The thumbnail images in the thumbnail list may be updated sequentially.

The display unit 280 may generate a driving signal by converting an image signal, a data signal, an OSD signal and a control signal processed in the controller 270, or an image signal, a data signal and a control signal received via the external device interface unit 230.

The display unit 280 may be implemented as a PDP, an LCD, an OLED, a flexible display, etc. Especially, the display unit 280 may be implemented as a three-dimensional (3D) display according to embodiments of the present invention.

The display unit 280 may be configured to provide a 3D image to a user. To view the 3D image, the display unit 280 may be classified into an additional displaying method and an independent displaying method. The independent displaying method may be configured such that a 3D image can be implemented only by the display unit 280 without a separate 3D viewer, for example, 3D glasses or the like. Various technologies such as a lenticular technology, a parallax barrier technology and the like may be applied as the independent displaying method. The additional displaying method may be configured to implement a 3D image by using the 3D viewer in addition to the display unit 280. As one example, various methods such as a head mount display (HMD) type, a glass type and the like may be applied.

Also, the glass type may be divided into a passive glass type such as a polarized glass type and the like, and an active glass type such as a shutter glass type and the like. The HMD type may also be divided into a passive HMD type and an active HMD type.

The 3D viewer 295 for viewing a 3D image may include a passive type polarized glass or an active type shutter glass, and includes the aforementioned head mount type.

The display unit 280 may be implemented as a touch screen so as to be used as an input device as well as an output device.

The audio output unit 285 may output sound by receiving an audio signal processed in the controller 270, for example, a stereo signal, a 3.1 channel signal or a 5.1 channel signal. The audio output unit 285 may be implemented as various types of speakers.

Meanwhile, to sense a user's gesture, as aforementioned, the image display device 200 may further include a sensing unit (not shown) having at least one of a touch sensor, a voice sensor, a location sensor, and a motion sensor. A signal sensed by the sensing unit may be transferred to the controller 270 via the user input interface unit 250.

The controller 270 may sense a user's gesture based on an image captured by a capturing unit (not shown), a signal sensed by the sensing unit (not shown) or a combination thereof.

A remote controller 260 may transmit a user input to the user input interface unit 250. To this end, the remote controller 260 may use various communication standards, such as IR communication, RF communication, Bluetooth, ultra wideband (UWB), Zigbee and the like. Also, the remote controller 260 may receive a video, audio or data signal output from the user input interface unit 250, so as to display the signal on the remote controller 260 or output the signal on the remote controller 260 in the form of sound.

The image display device 200 may be a fixed digital broadcast receiver capable of receiving at least one of ATSC (8-VSB) broadcast programs, DVB-T (COFDM) broadcast programs, and ISDB-T (BST-OFDM) broadcast programs or a mobile digital broadcast receiver capable of receiving at least one of terrestrial DMB broadcast programs, satellite DMB broadcast programs, ATSC-M/H broadcast programs, DVB-H (COFDM) broadcast programs, and Media Forward Link Only (MediaFLO) broadcast programs. Alternatively, the image display device 200 may be an IPTV digital broadcast receiver capable of receiving cable broadcast programs, satellite broadcast programs or IPTV programs.

The image display device disclosed herein may include a TV receiver, a cellular phone, a smart phone, a notebook computer, a digital broadcasting terminal, a personal digital assistant (PDA), a portable multimedia player (PMP) and the like.

The block diagram of the image display device illustrated in FIG. 2 is a block diagram of one exemplary embodiment. Each component of the block diagram may be combined, added or omitted according to the configuration of the image display device 200. That is, if necessary, two or more components may be combined into one component, or one component may be divided into two components. Also, a function performed in each block is merely illustrative, and a detailed operation or device may not limit the scope of the present disclosure.

An image signal decoded in the image display device 200 may be a 3D image of various formats. For instance, the image signal may be a 3D image signal composed of a color image and a depth image. Alternatively, the image signal may be a 3D image signal composed of multi-view image signals. The multi-view image signals may include a left-eye image signal and a right-eye image signal. A format of the 3D image signal may include a side by side method to dispose a left-eye image signal (L) and a right-eye image signal (R) from side to side, a top/down method to dispose left and right images up and down, a time sequential (frame by frame) method to dispose left and right images by time, a checker board method to dispose fragments of left and right images in a tile form, and an interlaced method to dispose left and right images alternately by columns and rows.

The aforementioned image display device may be applied to a mobile terminal. The mobile terminal may include cellular phones, smart phones, laptop computers, digital broadcast terminals, personal digital assistants (PDAs), portable multimedia players (PMPs), navigators, slate PCs, tablet PCs, ultra books, and the like.

In a case where the image display device is used as the mobile terminal, a wireless communication unit may be additionally provided.

The wireless communication unit may typically include one or more modules which permit wireless communications between the image display device 100 and a wireless communication system or between the mobile terminal and a network within which the mobile terminal is located. For example, the wireless communication unit may include at least one of a broadcast receiving module, a mobile communication module, a wireless Internet module, a short-range communication module, and a location information module.

The broadcast receiving module receives a broadcast signal and/or broadcast associated information from an external broadcast managing entity via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module 111 may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module may be configured to be suitable for every broadcast system transmitting broadcast signals as well as the digital broadcasting systems.

Broadcast signals and/or broadcast associated information received via the broadcast receiving module may be stored in a suitable device, such as a memory.

The mobile communication module transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module may implement a video call mode and a voice call mode. The video call mode indicates a state of calling with watching a callee's image. The voice call mode indicates a state of calling without watching the callee's image. The wireless communication module may transmit and receive at least one of voice and image in order to implement the video call mode and the voice call mode.

The wireless Internet module supports wireless Internet access for the mobile terminal. This module may be internally or externally coupled to the mobile terminal. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC) and the like.

The location information module denotes a module for detecting or calculating a position of a mobile terminal. An example of the location information module may include a Global Position System (GPS) module or a Wireless Fidelity (WiFi) module.

If the display unit and a touch sensitive sensor (referred to as a touch sensor) have a layered structure therebetween (referred to as a ‘touch screen’), the display unit may be used as an input device as well as an output device. The touch sensor may be implemented as a touch film, a touch sheet, a touchpad, and the like.

The touch sensor may be configured to convert changes of a pressure applied to a specific part of the display unit, or a capacitance occurring from a specific part of the display unit, into electric input signals. Also, the touch sensor may be configured to sense not only a touched position and a touched area, but also touch pressure. Here, a touch object is an object to apply a touch input to the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller. Accordingly, the controller may sense which region of the display unit has been touched.

The present invention relates to a three-dimensional (3D) display device, and provides a method and a method capable of compensating for a depth value of a screen, the depth value output so as to be close to a substantial image. Hereinafter, a method for compensating for such a depth value will be explained in more detail.

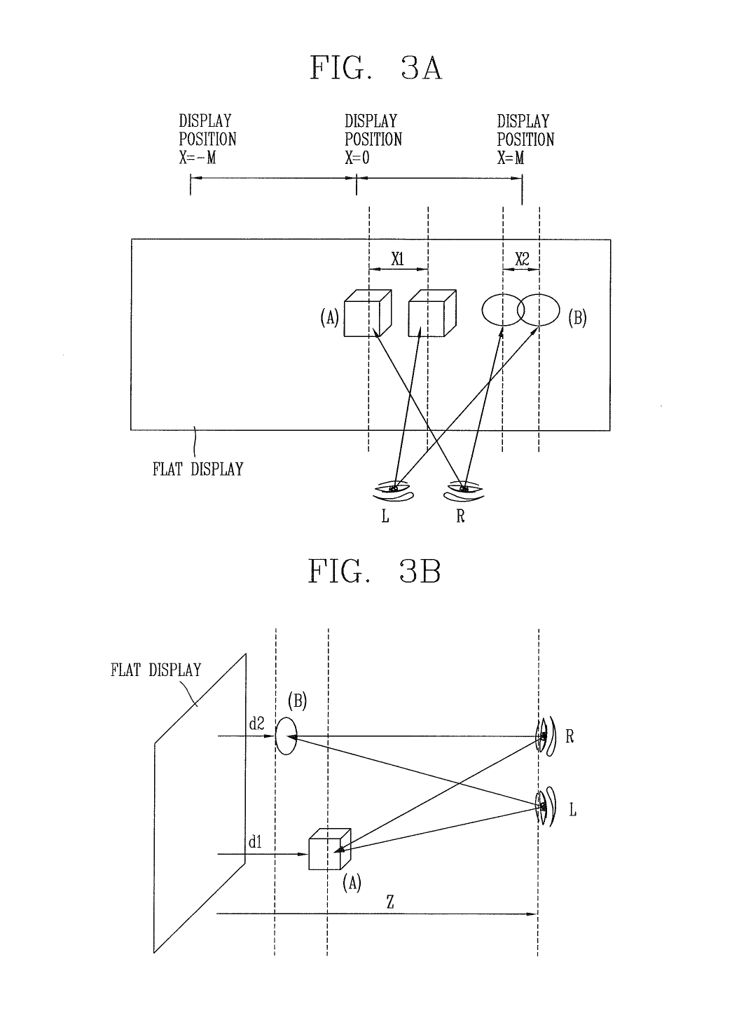

FIGS. 3A and 3B are exemplary views illustrating a stereoscopic object (a left-eye image and a right-eye image) displayed on a screen of a flat panel.

As shown in FIGS. 3A and 3B, when a stereoscopic object (A) (a left-eye image and a right-eye image) and a stereoscopic object (B) are displayed on a screen of a flat panel with disparities, X₁ and X₂, respectively, a user is provided with information on a 3D effect according to a depth. That is, when X₁ is larger than X₂ (X₂<X₁), the stereoscopic object (A) has a larger negative depth (a sense of protrusion in a 3D manner) than the stereoscopic object (B). A depth (d₁) of the stereoscopic object (A) may be obtained by the following formula 1.

$${d}_{1} = \frac{z}{( \frac{e}{{x}_{1} + 1} )} \qquad [ Formula 1 ]$$

Here, X₁ indicates a distance between the left-eye image and the right-eye image of the stereoscopic object (A), z indicates a distance from the screen of the flat panel to the user's two eyes, and e indicates a distance between the user's two eyes.

A depth (d₂) of the stereoscopic object (B) may be obtained by the following formula 2.

$${d}_{2} = \frac{z}{( \frac{e}{{x}_{2} + 1} )} \qquad [ Formula 2 ]$$

Here, X₂ indicates a distance between the left-eye image and the right-eye image of the stereoscopic object (B), z indicates a distance from the screen of the flat panel to the user's two eyes, and e indicates a distance between the user's two eyes.

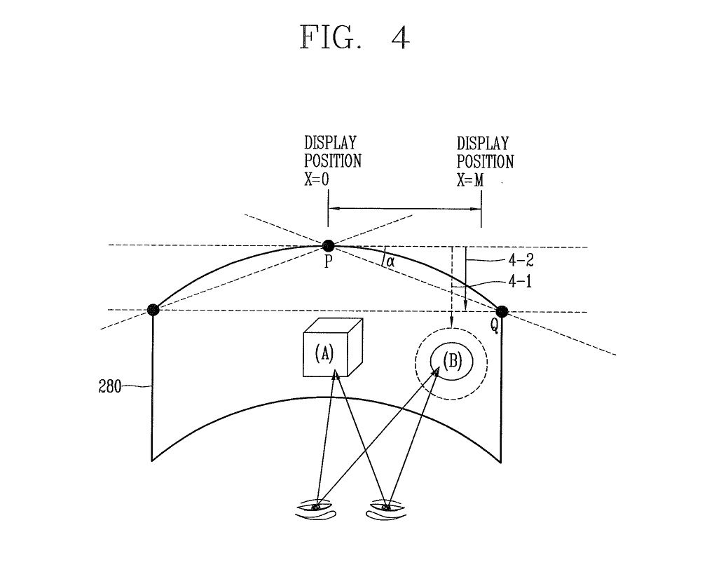

On the other hand, as shown in FIG. 4, a 3D curved-surface display using a film-type patterned retarder (FPR) or active-shutter glasses (SG) has a distorted 3D effect according to a curvature.

The image processing device and the method therefor according to an embodiment of the present invention may be applied to a 3D curved-surface display, and the display unit 151 of FIG. 1 and the display unit 280 of FIG. 2 may be 3D curved-surface displays. Hereinafter, the image processing device and the method therefor according to embodiments of the present invention will be explained with reference to the image display device 200.

FIG. 4 is an exemplary view illustrating a stereoscopic object displayed on a 3D curved-surface display (or flexible display).

As shown in FIG. 4, the 3D curved-surface display 280 has a distorted 3D effect according to its curvature (curvature angle). For instance, the 3D curved-surface display 280 may provide a user with a higher sense of reality than a flat display in case of a 2D image. However, in case of displaying a 3D image, the 3D curved-surface display 280 has a distorted 3D effect. That is, the stereoscopic object (A) positioned at a central shaft region of the 3D curved-surface display 280 (d₁) should seem to be more protruded than the stereoscopic object (B) positioned on a right side surface or a left side surface of the 3D curved-surface display 280 (d₂). However, the stereoscopic object (B) (d₂) is more protruded than the stereoscopic object (A) (d₁), due to a curvature of the 3D curved-surface display 280.

A substantial 3D effect of the stereoscopic object (A) (d₁) is the same as that of a flat display (the same depth), since the stereoscopic object (A) (d₁) is located at the central shaft region of the 3D curved-surface display 280. However, the stereoscopic object (B) (d₂) displayed at a position spaced from the central shaft region of the 3D curved-surface display 280 has a distorted 3D effect (depth) (P) (4-1) as shown in the following formula 3.

P=C+d₂,C=m [symbol] tan α [Formula 3]

Here, d₂ indicates a depth of the stereoscopic object (B), and C(4-2) indicates a curved depth of the 3D curved-surface display 280 corresponding to a display position of the stereoscopic object (B). m indicates a display position of the stereoscopic object (B), and α indicates a screen curvature (screen curvature angle) of the 3D curved-surface display 280. An angle of a tangent line which connects a point (P) positioned on a central shaft of the 3D curved-surface display 280 with a point (Q) corresponding to an end of the 3D curved-surface display 280 is defined as a curvature angle. That is, the stereoscopic object (B) has a distorted 3D effect by a curved depth (C) (or a curved-surface depth) of the 3D curved-surface display 280, the curved depth (C) corresponding to the display position of the stereoscopic object (B).

The distorted 3D effect (P) may be expressed as the following formula 4.

$$P = \frac{( m tan a ) ( \frac{e}{{x}_{2} + 1} ) + z}{( \frac{e}{{x}_{2} + 1} )} \qquad [ Formula 4 ]$$

In the image processing device and the method therefor according to an embodiment of the present invention, a depth distortion of the stereoscopic object (B) may be solved as the curved depth (C) of the 3D curved-surface display 280, which corresponds to a display position of the stereoscopic object (B) is compensated.

Hereinafter, an image processing device capable of compensating for a 3D image distorted by a screen curvature of a 3D curved-surface display by compensating for (changing) a depth value corresponding to a disparity between a left-eye image and a right-eye image (a stereoscopic object) included in a 3D image signal, according to the screen curvature of the 3D curved-surface display, and a method therefore will be explained with reference to FIGS. 2 to 7.

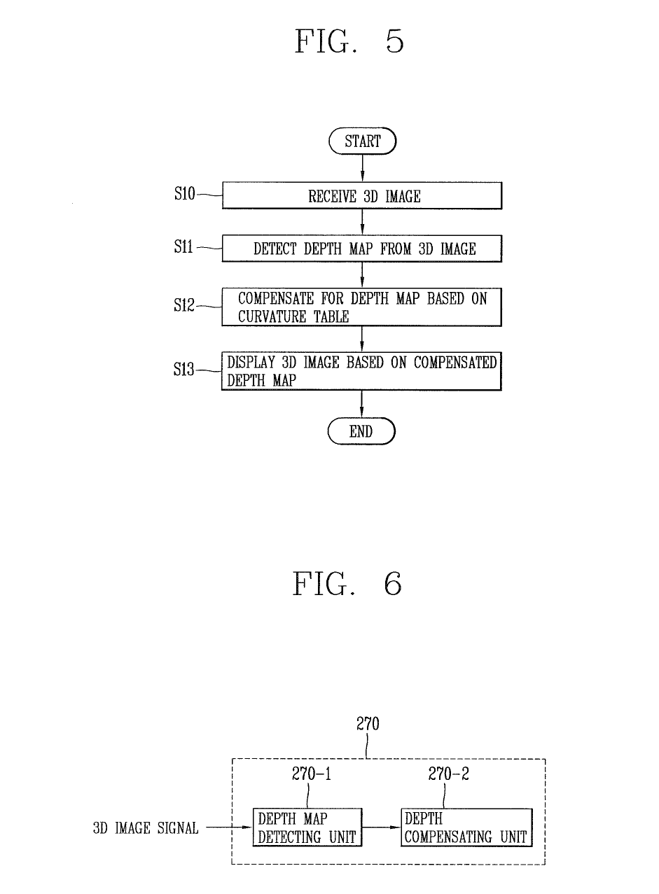

FIG. 5 is a flowchart illustrating an image processing method according to a first embodiment of the present invention.

Firstly, the controller 270 receives a 3D image signal (S10). For instance, the controller 270 receives a 3D image signal from an external device, through the tuner 210, the external device interface unit 230 or the network interface unit 235. Alternatively, the controller 270 may include a conversion unit configured to convert a 2D image signal received from the external device through the tuner 210, the external device interface unit 230 or the network interface unit 235, into a 3D image signal.

The controller 270 detects a depth map of a stereoscopic object (a left-eye image and a right-eye image) included in the 3D image signal (S11). For instance, the controller 270 detects the depth map from the 3D image signal, using a binocular cue or a stereo matching method.

The controller 270 compensates for the depth map of the stereoscopic object included in the 3D image signal, based on a curvature table (S12). The curvature table indicates a table for compensating for a depth map of stereoscopic objects, based on a curved depth of a screen of the 3D curved-surface display 280 corresponding to a pixel position of the 3D curved-surface display 280 in a horizontal direction. The curvature table is pre-stored in the storage unit 240. For instance, the controller 270 reads a curved depth (C) of the 3D curved-surface display 280 corresponding to a display position (pixel position) of a specific stereoscopic object included in the 3D image signal, from the curvature table, in order to compensate for a depth of the specific stereoscopic object. Then, the controller 270 deducts the read curved depth (C), from a depth value of the specific stereoscopic object, thereby compensating for the depth value of the specific stereoscopic object. The curved depth (C) of the 3D curved-surface display 280 may be variable according to a screen curvature of the 3D curved-surface display 280.

As shown in FIG. 6, the controller 270 may include a depth map detecting unit 270-1 and a depth compensating unit 270-2.

FIG. 6 is an exemplary view illustrating the controller of the image processing method according to a first embodiment of the present invention.

The controller 270 may include a depth map detecting unit 270-1 configured to detect a depth map of a stereoscopic object (a left-eye image and a right-eye image) included in the 3D image signal, and a depth compensating unit 270-2 configured to compensate for the detected depth map based on the curvature table.

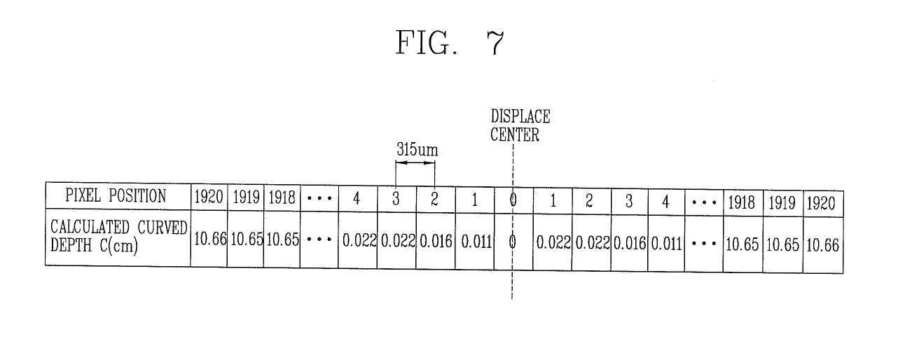

FIG. 7 is an exemplary view illustrating a curvature table according to a first embodiment of the present invention.

As shown in FIG. 7, a curved depth (C) of the 3D curved-surface display 280 corresponding to a pixel position of the 3D curved-surface display 280 in a horizontal direction is calculated in advance. Then, the calculated curved depth (C) is recorded in the curvature table. For instance, it is assumed that the 3D curved-surface display 280 has a resolution of 3840×2160, the curvature angle is 10°, and a single pixel has a width of 315 um. In this case, a curved depth (C) corresponding to each horizontal pixel position is recorded in the curvature table as shown in FIG. 6. If it is assumed that a curvature angle of the 3D curved-surface display 280 is 10°, a curvature depth of two ends of the screen of the 3D curved-surface display 280 may be 10 cm.

The controller 270 displays a 3D image on the 3D curved-surface display 280 based on the compensated depth map (S13). For instance, the controller 270 reads, from the curvature table, a curved depth (C) of the 3D curved-surface display 280 corresponding to a display position (pixel position) of a specific stereoscopic object, and deducts the read curved depth (C), from a depth value of the specific stereoscopic object as shown in the following formula 5. Then, the controller 270 displays the 3D image on the 3D curved-surface display 280, based on the deducted depth (newly-generated depth map). The controller 270 renders the left-eye image and the right-eye image of the 3D image using the deducted depth (newly-generated depth map). If the 3D image is a multi-view 3D image, the controller 270 selects a left-eye image and a right-eye image from the multi-view 3D image by a multi-view synthesis method, and then renders the selected left-eye image and right-eye image, based on the deducted depth (newly-generated depth map).

NewMapᵢ=OrgMapᵢ−mᵢ×tan αᵢ [Formula 5]

Here, Org Map indicates a depth map (depth value) of the original stereoscopic object included in the 3D image, and i indicates a pixel position of the 3D curved-surface display 280 corresponding to a horizontal line.

In the image processing device and the method therefor according to an embodiment of the present invention, a 3D image distorted by a screen curvature of the 3D curved-surface display can be compensated as a depth value corresponding to a disparity between a left-eye image and a right-eye image included in a 3D image signal is compensated (changed) according to the screen curvature of the 3D curved-surface display.

Hereinafter, an image processing device capable of effectively compensating for a 3D image distorted by a screen curvature of the 3D curved-surface display, by selectively compensating for (changing) a depth value corresponding to a disparity between a left-eye image and a right-eye image included in a 3D image signal according to the screen curvature of the 3D curved-surface display, or by controlling the compensated depth value according to a user's input, and a method therefore will be explained with reference to FIGS. 2 to 10.

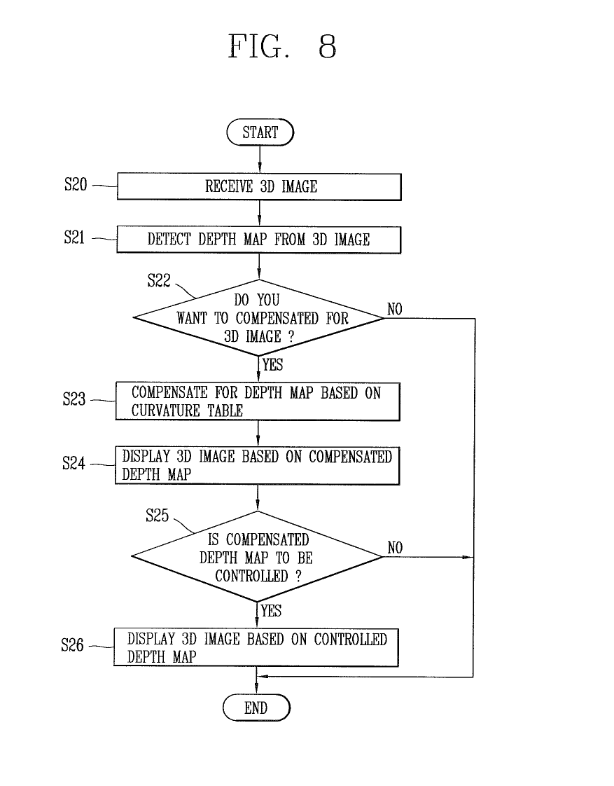

FIG. 8 is a flowchart illustrating an image processing method according to a second embodiment of the present invention.

Firstly, the controller 270 receives a 3D image signal (S20). For instance, the controller 270 receives a 3D image signal from an external device through the tuner 210, the external device interface unit 230 or the network interface unit 235. Alternatively, the controller 270 may include a conversion unit configured to convert a 2D image signal received from the external device through the tuner 210, the external device interface unit 230 or the network interface unit 235, into a 3D image signal.

The controller 270 detects a depth map of a stereoscopic object (a left-eye image and a right-eye image) included in the 3D image signal (S21). For instance, the controller 270 detects the depth map from a 3D image, using a binocular cue or a stereo matching method.

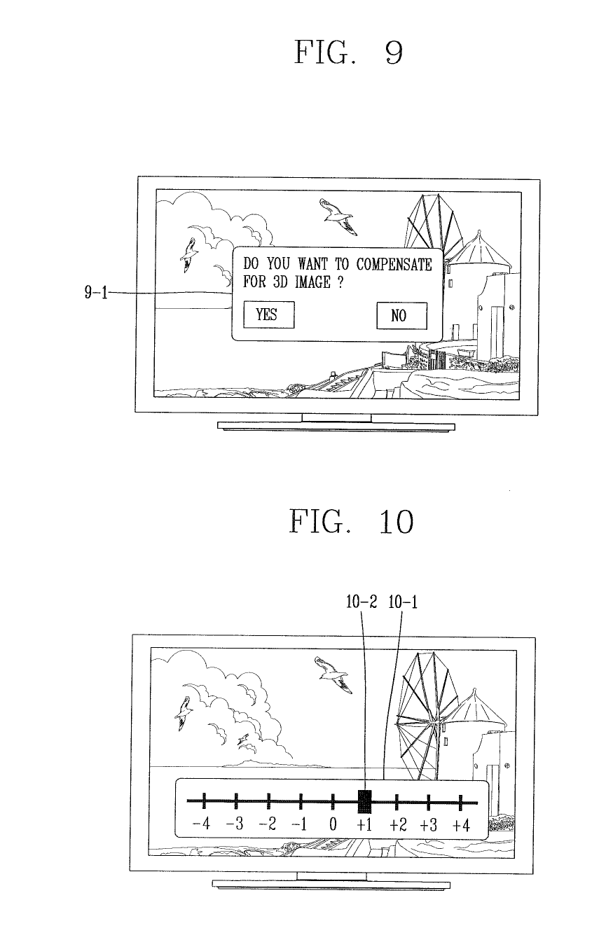

The controller 270 displays a window on the 3D curved-surface display 280 as shown in FIG. 9, the window inquiring whether to compensate for the depth map of the stereoscopic objects included in the 3D image signal based on the curvature table (S22).

FIG. 9 is an exemplary view illustrating a displayed window according to a second embodiment of the present invention.

As shown in FIG. 9, the controller 270 displays, on the 3D curved-surface display 280, a window (9-1) inquiring whether to compensate for the depth map of the stereoscopic objects included in the 3D image signal based on the curvature table (e.g., Do you want to compensate for a 3D image?).

If a request for compensating for the depth map is received in response to the displayed window (9-1), the controller 270 compensates for the depth map of the stereoscopic objects included in the 3D image signal based on the curvature table (S23). For instance, the controller 270 reads a curved depth (C) of the 3D curved-surface display 280 corresponding to a display position (pixel position) of a specific stereoscopic object included in the 3D image signal, from the curvature table, in order to compensate for a depth of the specific stereoscopic object. Then, the controller 270 deducts the read curved depth (C), from a depth value of the specific stereoscopic object, thereby compensating for the depth value of the specific stereoscopic object.

The controller 270 displays the 3D image on the 3D curved-surface display 280, based on the compensated depth map (S24). For instance, the controller 270 reads a curved depth (C) of the 3D curved-surface display 280 corresponding to a display position (pixel position) of the specific stereoscopic object, from the curvature table. Then, the controller 270 deducts the read curved depth (C), from the depth value of the specific stereoscopic object as shown in the formula 5. Then, the controller 270 displays the 3D image on the 3D curved-surface display 280, based on the deducted depth (newly-generated depth map).

The controller 270 determines whether a user's input for controlling the compensated depth map has been received or not (S25). For instance, the controller 270 determines whether an icon, a button or the like for controlling the compensated depth map has been input by a user.

Upon reception of the user's input for controlling the compensated depth map, the controller 270 controls the compensated depth map according to the user's input, and displays the 3D image on the 3D curved-surface display 280, based on the controlled depth map (S26).

As shown in FIG. 10, the controller 270 may display a depth control bar for controlling the compensated depth map, on the 3D curved-surface display 280.

FIG. 10 is an exemplary view illustrating a depth control bar displayed according to a second embodiment of the present invention.

As shown in FIG. 10, upon reception of the user's input for controlling the compensated depth map, the controller 270 displays a depth control bar 10-1 for controlling the compensated depth map, on the 3D curved-surface display 280. For instance, as a depth control value 10-2 displayed on the depth control bar 10-1 is increased according to a user's request, the controller 270 increases the read curved depth (C). On the contrary, as the depth control value 10-2 displayed on the depth control bar 10-1 is decreased according to a user's request, the controller 270 decreases the read curved depth (C). In such a manner, the controller 270 controls the compensated depth map. Alternatively, if the depth control value 10-2 displayed on the depth control bar 10-1 is increased according to a user's request, the controller 270 may increase a depth value corresponding to the detected depth map. On the other hand, if the depth control value 10-2 displayed on the depth control bar 10-1 is decreased according to a user's request, the controller 270 may decrease a depth value corresponding to the detected depth map.

In the image processing device and the method therefor according to a second embodiment of the present invention, a 3D image distorted by a screen curvature of the 3D curved-surface display may be compensated as a depth value corresponding to a disparity between a left-eye image and a right-eye image included in a 3D image signal is selectively compensated (changed) according to the screen curvature of the 3D curved-surface display, or as the compensated depth value is controlled according to a user's input.

Hereinafter, an image processing device capable of compensating for a 3D image distorted by change of a screen curvature of a 3D curved-surface display by automatically compensating for (changing) a depth value corresponding to a disparity between a left-eye image and a right-eye image (a stereoscopic object) included in a 3D image signal, according to change of the screen curvature of the 3D curved-surface display, and a method therefore will be explained with reference to FIGS. 2 to 13.

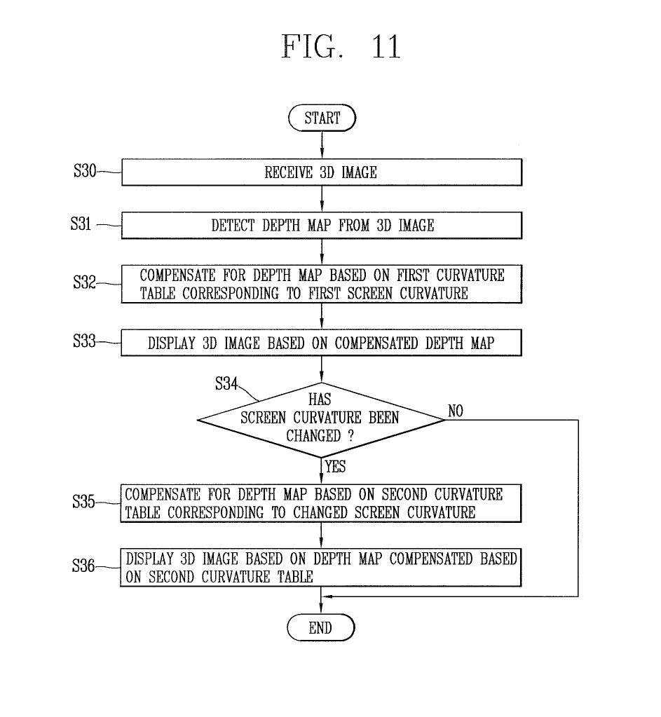

FIG. 11 is a flowchart illustrating an image processing method according to a third embodiment of the present invention.

Firstly, the controller 270 receives a 3D image signal (S30). For instance, the controller 270 receives a 3D image signal from an external device, through the tuner 210, the external device interface unit 230 or the network interface unit 235. Alternatively, the controller 270 may include a conversion unit configured to convert a 2D image signal received from the external device through the tuner 210, the external device interface unit 230 or the network interface unit 235, into a 3D image signal.

The controller 270 detects a depth map of a stereoscopic object (a left-eye image and a right-eye image) included in the 3D image signal (S31). For instance, the controller 270 detects the depth map from the 3D image signal, using a binocular cue or a stereo matching method.

The controller 270 compensates for a depth map of the stereoscopic objects included in the 3D image signal, based on a first curvature table corresponding to a current screen curvature (e.g., 10°) of the 3D curved-surface display 280 (S32). For instance, the controller 270 reads a curved depth (C) of the 3D curved-surface display 280 corresponding to a display position (pixel position) of a specific stereoscopic object included in the 3D image signal, from the curvature table, in order to compensate for a depth of the specific stereoscopic object. Then, the controller 270 deducts the read curved depth (C), from a depth value of the specific stereoscopic object, thereby compensating for the depth value of the specific stereoscopic object. The curved depth (C) of the 3D curved-surface display 280 may be variable according to a screen curvature of the 3D curved-surface display 280. The curved depth (C) of the 3D curved-surface display 280 corresponding to the screen curvature of the 3D curved-surface display 280 may be recorded in a plurality of curvature tables. For instance, when a screen curvature angle of the 3D curved-surface display 280 is 1°, 2° and N°, the curved depth (C) of the 3D curved-surface display 280 corresponding to each curvature angle may be recorded in a first curvature table, a second curvature table, . . . an N^{th} curvature table.

The controller 270 displays the 3D image on the 3D curved-surface display 280 based on the compensated depth map (S33). For instance, the controller 270 reads, from the curvature table, a curved depth (C) of the 3D curved-surface display 280 corresponding to a display position (pixel position) of a specific stereoscopic object, and deducts the read curved depth (C), from a depth value of the specific stereoscopic object as shown in the formula 5. Then, the controller 270 displays the 3D image on the 3D curved-surface display 280, based on the deducted depth (newly-generated depth map).

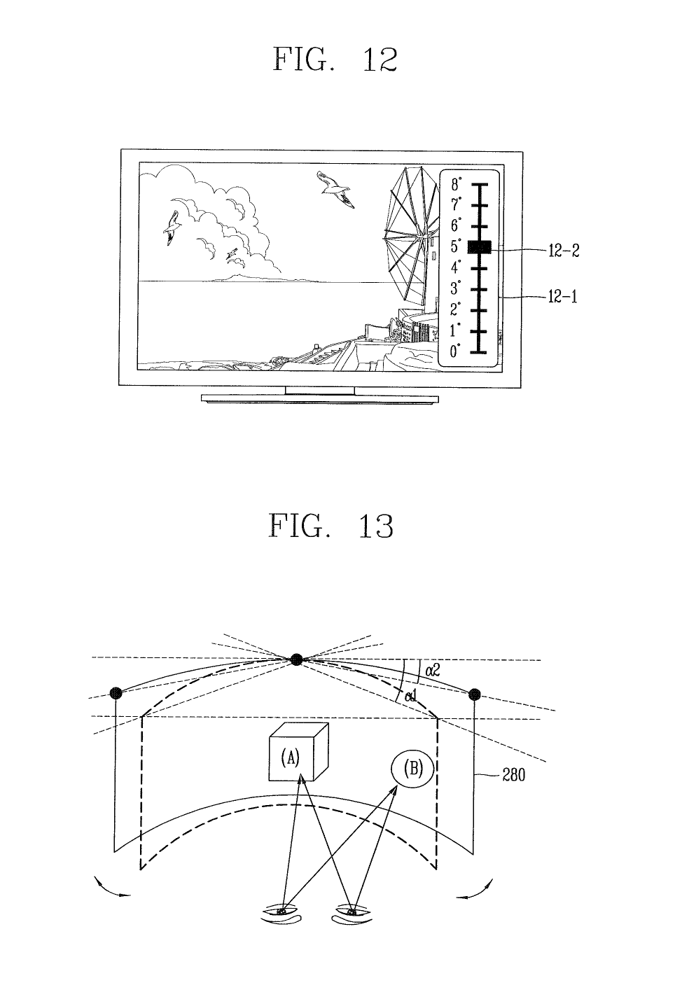

The controller 270 determines whether a screen curvature of the 3D curved-surface display 280 has been changed according to a user's request (S34). For instance, if a user selects a screen curvature control mode, the controller 270 displays a screen curvature control bar for controlling the screen curvature, on the 3D curved-surface display 280, as shown in FIG. 12.

FIG. 12 is an exemplary view illustrating a screen curvature control bar according to a third embodiment of the present invention.

As shown in FIG. 12, if a screen curvature control mode is selected by a user, the controller 270 displays a screen curvature control bar 12-1 for controlling the screen curvature, on the 3D curved-surface display 280. For instance, the user may select one of a plurality screen curvature angles (0°˜N°) using the screen curvature control bar 12-1. Here, the ‘N’ is a natural number.

An image processing device according to a third embodiment of the present invention may further include a driving unit configured to change the screen curvature into a specific curvature (curvature angle) selected by using the screen curvature control bar 12-1 (e.g., change to 5° from 10°). For instance, if a screen curvature 12-2 of 5° is selected by a user, the controller 270 generates a control signal for changing a screen curvature (a screen curvature angle) of the 3D curved-surface display 280 into 5°. Then, the controller 270 outputs the generated control signal to the driving unit. The driving unit physically moves the screen of the 3D curved-surface display 280 based on the control signal, such that a screen curvature angle of the 3D curved-surface display 280 is 5°. A structure for moving the screen so as to obtain a specific curvature angle may be implemented in the present invention in various manners, and thus its detailed structure will be omitted.

FIG. 13 is an exemplary view illustrating a changed state of a screen curvature according to a third embodiment of the present invention.

As shown in FIG. 13, when a screen curvature angle of the 3D curved-surface display 280 is changed to 5° (α₂) from 10° (α₁), the controller 270 compensates for a depth map of stereoscopic objects included in the 3D image signal, based on a second curvature table corresponding to the screen curvature angle (S35).

The controller 270 displays the 3D image on the 3D curved-surface display 280, based on the depth map compensated based on the second curvature table (S36). For instance, when a screen curvature angle of the 3D curved-surface display 280 is changed to 5° (α₂) from 10° (α₁), the controller 270 reads the second curvature table corresponding to the changed screen curvature angle, from the storage unit 240. Then, the controller 270 reads a curved depth (C) of the 3D curved-surface display 280 corresponding to a display position (pixel position) of a stereoscopic object, from the read second curvature table. Then, the controller 270 deducts the read curved depth (C), from a depth map of the stereoscopic object. Then, the controller 270 displays the 3D image on the 3D curved-surface display 280, based on the deducted depth (newly-generated depth map).

In the image processing device and the method therefor according to a third embodiment of the present invention, a 3D image distorted by change of a screen curvature of the 3D curved-surface display can be compensated as a depth value corresponding to a disparity between a left-eye image and a right-eye image included in a 3D image signal is compensated (changed) according to change of the screen curvature of the 3D curved-surface display.

As aforementioned, in the image processing device and the method therefor according to embodiments of the present invention, a 3D image distorted by a screen curvature of the 3D curved-surface display can be compensated as a depth value corresponding to a disparity between a left-eye image and a right-eye image included in a 3D image signal is compensated (changed) according to the screen curvature of the 3D curved-surface display.

In the image processing device and the method therefor according to embodiments of the present invention, a 3D image distorted by a screen curvature of the 3D curved-surface display can be effectively compensated as a depth value corresponding to a disparity between a left-eye image and a right-eye image included in a 3D image signal is selectively compensated (changed) according to the screen curvature of the 3D curved-surface display, or as the compensated depth value is controlled according to a user's input.

In the image processing device and the method therefor according to embodiments of the present invention, a 3D image distorted by change of a screen curvature of the 3D curved-surface display can be compensated as a depth value corresponding to a disparity between a left-eye image and a right-eye image included in a 3D image signal is compensated (changed) according to change of the screen curvature of the 3D curved-surface display.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

1. An image processing method, comprising:
receiving a 3D image signal;
changing a depth value of a left-eye image and a right-eye image included in the received 3D image signal, according to a screen curvature of an image display device; and
displaying the left-eye image and the right-eye image updated based on the changed depth value on a screen of the image display device, such that the 3D image signal is output after being compensated.

2. The method of claim 1, wherein in the step of changing a depth value, the depth value of the left-eye image and the right-eye image included in the received 3D image signal is changed according to the screen curvature, when the image display device is in a compensation mode.

3. The method of claim 1, further comprising controlling the depth value of the left-eye image and the right-eye image according to a user's input, or controlling the changed depth value according to the user's input.

4. The method of claim 1, further comprising changing the depth value of the left-eye image and the right-eye image included in the received 3D image signal, according to the changed screen curvature, when the curvature screen of the image processing device is changed.

5. The method of claim 1, wherein the step of changing a depth value includes:
pre-storing a depth value of the screen curvature corresponding to a pixel position of the image display device, in a curvature table;
reading a curved depth corresponding to a display position of the left-eye image and the right-eye image, from the curvature table; and
deducting the read curved depth, from the depth value of the left-eye image and the right-eye image, thereby changing the depth value of the left-eye image and the right-eye image.

6. The method of claim 1, wherein the changed depth value (NewMapᵢ) is calculated by a formula,
NewMapᵢ=OrgMapᵢ−mᵢ [symbol] tan αᵢ
wherein Org Map indicates a depth map (depth value) of the left-eye image and the right-eye image,
wherein m indicates a display position of the left-eye image and the right-eye image,
wherein α indicates a screen curvature angle of the image display device, and
wherein i indicates a pixel position of the image display device corresponding to a horizontal line.

7. An image processing device, comprising:
a receiving unit configured to receive a 3D image signal having a left-eye image and a right-eye image;
a controller configured to change a depth value of the left-eye image and the right-eye image, according to a screen curvature of an image display device; and
a 3D curved-surface display configured to display the left-eye image and the right-eye image updated based on the changed depth value, such that the 3D image signal is output after being compensated.

8. The device of claim 7, wherein the controller changes the depth value of the left-eye image and the right-eye image included in the received 3D image signal according to the screen curvature, when the image display device is in a compensation mode.

9. The device of claim 7, wherein the controller controls the depth value of the left-eye image and the right-eye image according to a user's input, or controls the changed depth value according to the user's input.

10. The device of claim 7, wherein upon change of the curvature screen of the image display device, the controller changes the depth value of the left-eye image and the right-eye image included in the received 3D image signal, according to the changed screen curvature.

11. The device of claim 10, further comprising a driving unit configured to change a screen curvature of the image display device.

12. The device of claim 11, wherein upon reception of a request for changing the screen curvature, the controller generates a control signal for changing the screen curvature of the image display device according to the request, and outputs the generated control signal to the driving unit.

13. The device of claim 7, further comprising a storage unit configured to pre-store a depth value of the screen curvature corresponding to a pixel position of the image display device, in a curvature table,
wherein the controller reads a curved depth corresponding to a display position of the left-eye image and the right-eye image, from the curvature table, and
wherein the controller deducts the read curved depth, from the depth value of the left-eye image and the right-eye image, thereby changing the depth value of the left-eye image and the right-eye image.
